(19) United States
(12) Patent Application Publication
(10) Pub. No.: US 2016/0004083 A1
(43) Pub. Date: Jan. 7, 2016

(54) SUPPORT DEVICE FOR ELECTRONIC DISPLAY UNITS

(71) Applicant: i-mmersive UG (haftungsbeschränkt), Berlin (DE)

(72) Inventor: Fax Quintus, Berlin (DE)

(21) Appl. No.: 14/755,620

(22) Filed: Jun. 30, 2015

(30) Foreign Application Priority Data
Jul. 1, 2014 (DE) 10 2014 009 745.5

(51) Int. Cl. G02B 27/01; G02B 19/00

(52) U.S. Cl. CPC G02B 27/0176; G02B 19/0033

(57) ABSTRACT

A support device for an electronic display unit includes a holding device for holding an electronic display unit on the support device, and a fastening device for fastening the support device onto a user's head. The support device is foldable and designed so as to be able to assume at least two operating states. In the first operating state, the support device has a flat, substantially spatially two-dimensional volume, and cannot be fastened to the user's head. In the second operating state, the support device has a spatially three-dimensional volume and can be fastened to the user's head. The support device can be transferred by being folded from the first operating state to the second operating state, and vice versa.

### CROSS REFERENCE TO RELATED APPLICATION

This application is a non-provisional application claiming priority from German Patent Application No. DE 10 2014 009 745.5, filed Jul. 1, 2014, and incorporated herein by reference in its entirety.

### FIELD OF THE INVENTION

The present invention relates generally to support devices for electronic display units. In particular, the invention relates to a support device making it possible to support an electronic display unit on a user's head.

### BACKGROUND OF THE INVENTION

There are well-known support devices that make it possible to support electronic display devices, such as smartphones, on a user's head. The known support devices are supported such that a screen of the display device is located at a defined distance in front of the user's eyes. The user is able to view videos, images, and the like on the screen. In order to avoid disturbances during viewing, e.g., because of light penetrating in from the outside, the known support devices comprise an opaque frame shaped in a manner similar to a tube section. At one end, the frame generally has a contact surface for the user's head. At the opposite end, the frame generally has a mount that receives the electronic display unit.

Typically, the known support devices for electronic display units are made with a solid, rigid material, often plastic. In size, known support devices are comparable to commercially available diving goggles.

The present invention addresses the problem of providing an improved support device for electronic display units. In particular, the invention addresses the problem of providing an inexpensive and easily transportable support device for electronic display units.

### SUMMARY OF THE INVENTION

According to a first aspect, the present invention provides a support device for electronic display units in accordance with the subject of independent claim 1.

Further aspects and features of preferred embodiments of the invention arise from the dependent claims, the accompanying drawings, and the following description.

### BRIEF DESCRIPTION OF THE DRAWINGS

An embodiment of the invention shall now be described by way of example and with reference to the accompanying drawings.

FIGS. 1A-1D illustrate a support device for an electronic display unit in the so-called display state.

FIG. 2 illustrates the support device of FIGS. 1A-1D in the so-called transport state.

FIGS. 3A-3D illustrate the transfer of the support device of FIGS. 1A-1D and FIG. 2 from the transport state to the display state.

### DETAILED DESCRIPTION

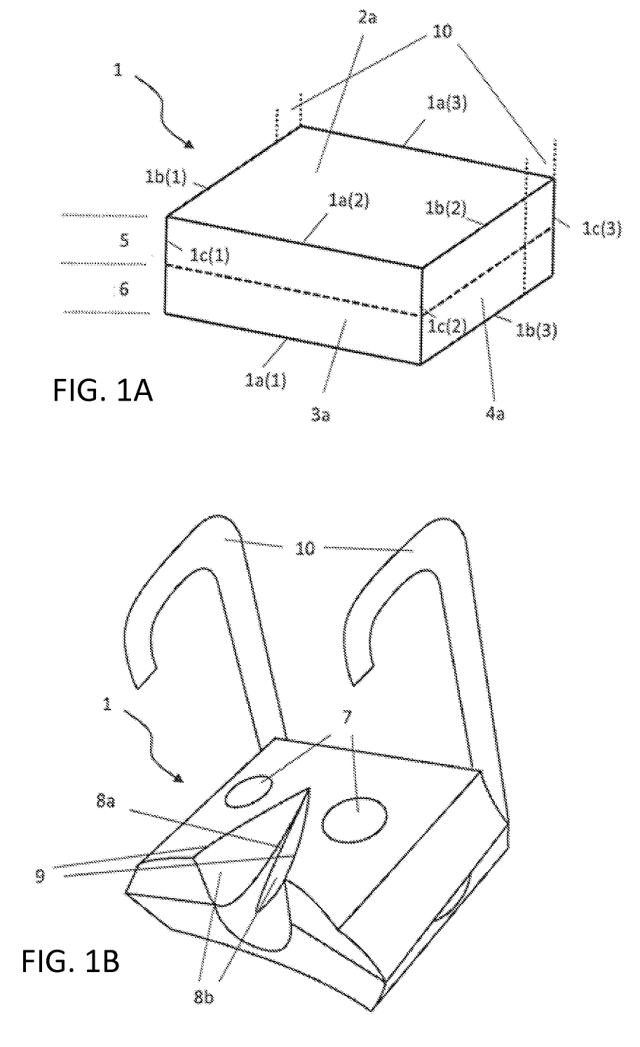

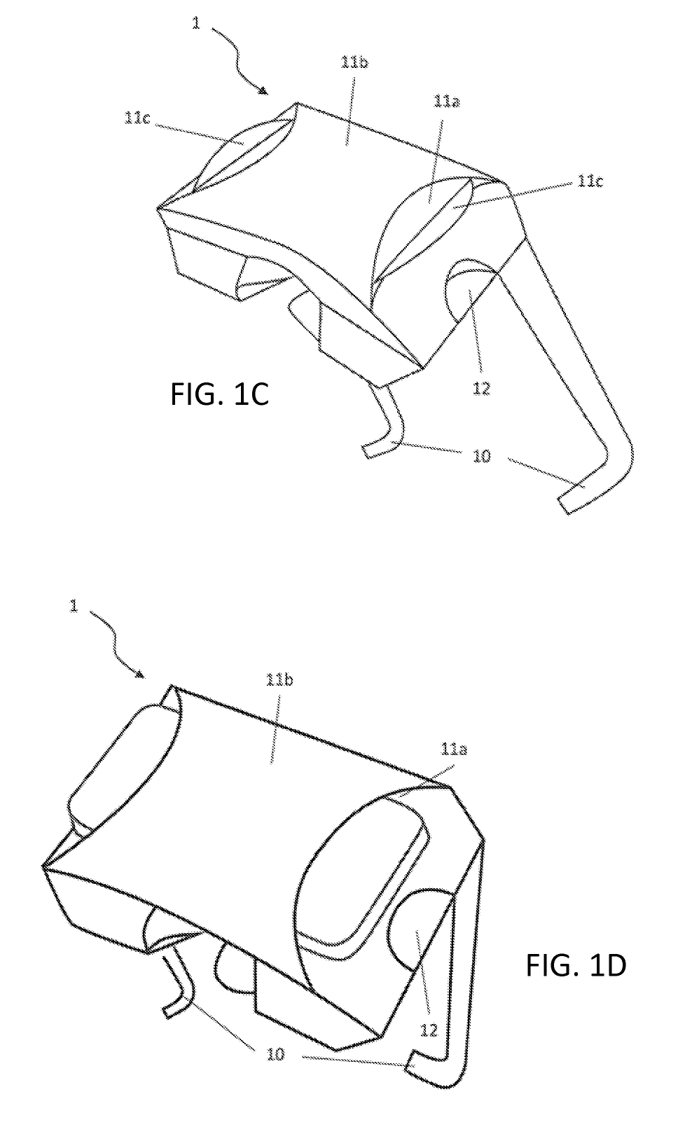

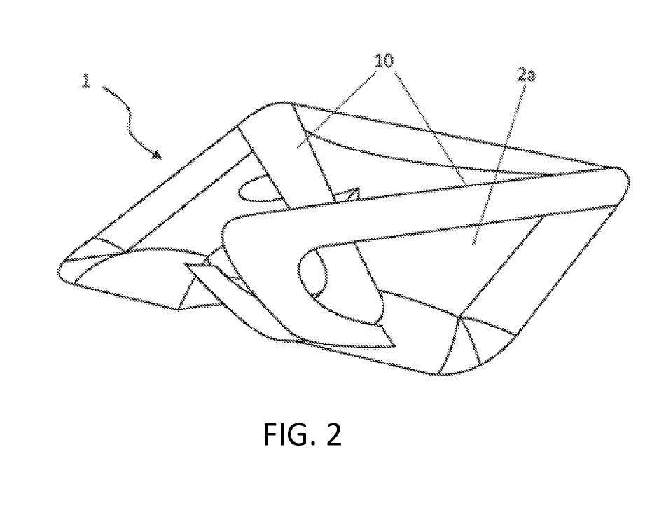

FIGS. 1A-1D, 2, and 3A-3D illustrate one embodiment of a support device for an electronic display unit in accordance with the present invention. A detailed description shall be preceded first by some general explanations of embodiments of the invention.

Within the framework of the invention, an electronic display unit refers to any electronic unit capable of playing back visual media such as images or videos. Often, a screen is used for playback of the visual media, but other forms of playback are also conceivable, e.g., by means of a projector. For the purpose of simplicity, the description below describes solely electronic display devices that have a screen. The invention shall not, however, be limited to such display devices.

The support device according to the invention comprises a holding device and a fastening device. The electronic display unit is held onto the support device by means of the holding device. Here, the holding device can be configured in a variety of ways, such that the electronic display unit can be fastened to the support device by means of the holding device. The holding device should not obscure the screen of the display device. The holding device may be configured as a clamp, which clamps and thus fixes the display unit in parts of the edge region. Such clamps are known, e.g., from holding systems for retrofit car navigation systems. Likewise, the holding device may be configured so as to almost completely surround and enclose the display device as far as the screen, similar to with a protective covering of a smartphone. Electronic display devices are often equipped with video cameras. These are regularly mounted onto the front ends of the display devices, both on the side on which the screen is located, and on the side opposite to the screen. Holding devices may be configured so as to omit the forehead region or other regions in which a video camera of a display device is located. This also then makes it possible to record video, if the display device is located in the holding device.

The fastening device serves to fasten the support device onto a user's head. With the fastening device, the support device is thus fastened onto the user's head so as to be secure and not fall out of place even in the user's everyday, typical movements. As a fastening device, it is possible to use rubber bands, similar to with swimming goggles, or also ear hooks, similar to with conventional optical glasses. A variety of further embodiments of fastening devices are also conceivable.

The support device according to the invention is designed so as to be foldable. The terms “fold” or “folding” are understood here to mean altering the form of the support device in a manner that is achievable through pulling and pushing movements, is intended, and is reproducible. The alteration in the shape of the support device that is achievable by folding is preferably predetermined by previously defined fold lines, and is reversible.

The support device according to the invention is designed so as to be able to assume at least two different operating states. The support device can thereby be transferred by being folded along the predefined fold lines from the first operating state to the second operating state, and vice versa.

In the first operating state (hereinafter called a “transport state”), the support device has a flat, substantially spatially two-dimensional volume. Thus, the support device in the transport state occupies the lowest possible volume of space. The transport state serves primarily as a space-saving stowage of the support device during transport thereof. In the transport state, it is not intended for the eyeglasses to be fastened to the user's head by means of the fastening device.

In the second operating state (hereinafter called a “display state”), the transport device has a spatially three-dimensional volume. In the display state, the support device can be fastened to the user's head by means of the fastening device. The display state is designed so that the user is able to view, as comfortably as possible, the screen of a display device that has been fastened onto the support device when the support device has been fastened onto the user's head. In particular, the support device in the display state can be designed so as to rest as ergonomically as possible on the user's face.

In some embodiments, the support device in the display state may be fastened by means of the fastening device to the user's head such that the screen of the electronic display unit located in the holding device is arranged substantially frontally and at a fixed distance in front of the user's eyes. A frontal arrangement in front of the user's eyes shall be understood to mean that the normal vector of the screen plane is substantially perpendicular to an imaginary straight line passing through both of the user's eyes. The frontal arrangement of the screen in front of the viewer's eyes ensures a pleasant viewing of media content being played back on the screen. For a pleasant viewing of media content, it is further advantageous if the distance between the screen and eyes is constant over the duration of the viewing. This can be achieved by both fastening the fastening device to the user's head so that the support device does not fall out of place during normal use, and arranging the display device in a slip-resistant manner in the holding device. It is also beneficial if the entire support device has an appropriate rigidity so as not to begin vibrating in the user's everyday movements.

In some embodiments, the support device in the display state is designed so that the space between the screen and the user's eyes is bounded by the sides of the support device, if the support device has been fastened onto the user's head. Such a lateral bordering creates a space between the user's eyes and the screen that is closed off to the outside. Substantially no dust, sand, wind, or the like is able to penetrate from the outside into the enclosed space. In some embodiments, the side surfaces of the support device are made out of a lightproof material. Thus, in these embodiments, substantially no light can penetrate into the enclosed space. Such a configuration of the sides of the support device guarantees that media content on the screen can be viewed largely without interference from external disturbances.

In some embodiments, the support device comprises a substantially rectangular cuboid base body, the base body comprising a front side at which the holding device is arranged, a reverse side in which two circular eye openings are arranged, at least partially surrounding side surfaces, at least partially predefined fold seams that run substantially parallel to the front side and the reverse being arranged along the side surfaces, wherein the base body can be transferred by being folded along the predefined fold seams from the second operating state to the first operating state, and vice versa.

In some embodiments, the support device comprises at least one optical condenser lens. Such a condenser lens enables relaxed viewing of media content on the screen of the display unit, even when there is little distance between the screen and eyes. The use of a condenser lens thus permits a compact dimensioning of the support device, even in the display state. In some embodiments, the lens is arranged in the enclosed space between the user's eyes and the screen in front of the user's eyes. In some embodiments, a plurality of condenser lenses is used. Often, two condenser lenses are used. In these embodiments, one condenser lens is arranged directly in front of each of the user's eyes. In some embodiments having two condenser lenses, the condenser lenses are each additionally equipped with a so-called “shutter”. The shutter can open or close the condenser lens in accordance with the media content on the screen. The use of such a shutter makes it possible to generate a three-dimensional perception when the corresponding media content is being viewed.

In some embodiments, the fastening device comprises two ear hooks. With the aid of the ear hooks, the support device in the display state can be fastened onto the user's ears.

In some embodiments, the fastening device comprises a nose clip. With the aid of the nose clip, the support device in the display state can be fastened onto the user's nose.

In some embodiments, the fastening device comprises both two ear hooks and a nose clip. In such embodiments, the support device in the display state can be fastened onto the user's face by means of the ear hooks and the nose clip, in a manner similar to the manner in commercially available optical eyeglasses. In such embodiments, the support device may be similar in appearance to a pair of optical eyeglasses. In lieu of spectacle eyeglasses, the aforementioned condensers can be located there. In such embodiments, the holding device may be located in the short distance to the condenser lenses, on the side of the condenser lenses that faces away from the eyes. In the holding device, an electronic display unit can be fastened in such a manner that the screen thereof is arranged frontally and at a fixed distance in front of the user's eyes.

In some embodiments in which the fastening device comprises two ear hooks, the longitudinal axes of the two ear hooks in the transport state are arranged substantially parallel to the spatially two-dimensional volume of the support device. The arrangement of the support device is then comparable to the arrangement of optical eyeglasses in an eyeglass case. In the display state, the two ear hooks are essentially arranged so as to be perpendicular to the screen of the electronic display unit provided in the holding device. This is comparable to the arrangement of earpieces on optical eyeglasses, if the optical eyeglasses are being worn by a user.

In some embodiments, the support device in the transport state substantially completely surrounds an electronic display unit located in the holding device. The nearly complete surrounding of the display unit causes the support device in the transport state to exert a protective function with regard to the electronic display unit. In such embodiments, the support device in the transport state acts as a protective cover for the display unit.

In some embodiments, the support device is substantially formed of a flexible and foldable material. Preferred materials here include, in particular, paper, metal, paper, leather, and plastic.

In some embodiments, the electronic display unit is a mobile telephone, a smartphone, a mobile video player, a mobile image playback unit, or any other mobile display unit having a screen.

Returning now to the drawings, FIGS. 1A-1D, 2, and 3A-3D schematically illustrate a specific embodiment of a support device for an electronic display unit according to the invention.

FIGS. 1A to 1D illustrate the support device in the display state, i.e., in a state in which the significant difference can be fastened onto a user's face. The support device in the display state consists essential of a body 1 similar in shape to a rectangular cuboid. Herein, the body 1 is not exactly rectangular cuboid in shape. Only the rough shape thereof corresponds to a rectangular cuboid.

Functionally and geometrically, the body 1 can be roughly divided into two sections. The first section, a fastening section 5, is situated on the user's face when the support device is being used. The second section, a holding section 6, accommodates an electronic display unit when the support device is being used.

FIG. 1A illustrates a schematic representation of the body 1 of the support device in the display state. In this representation, the body 1 is represented in a simplified manner as an ideal rectangular cuboid having edges 1a, 1b, and 1c. Parallel edges are then consecutively numbered (1), (2), and so forth. The rectangular cuboid is bounded by the six side surfaces 2a, 2b, 3a, 3b, 4a, 4b. The side surfaces 2b, 3b, 4b, which run parallel to the corresponding side surfaces 2a, 3a, 4a, are not shown in FIG. 1A. The upper half of the body 1 constitutes the fastening section 5. It is upwardly bounded by the side surface 2a, which is spanned by the edges 1a and 1b. The lower half of the body 1 constitutes the holding section 6. The holding section 6 is bonded at the bottom by the side surface 2b. The two ear hooks 10 of the support device are indicated by broken lines in FIGS. 1A-1D. In the display state, the ear hooks lie substantially perpendicular to the side surfaces 2a, b, and extend in the direction of the fastening section 5 away from the body 1.

FIGS. 1B to 1D illustrate detailed depictions of the embodiment of the support device. Even if the body 1 in the detailed depiction of the support device only roughly corresponds to a rectangular cuboid, the reference symbols introduced in FIG. 1A for the edges and side surfaces are used analogously for the description of FIGS. 1B to 1D for the purpose of ease of orientation.

FIG. 1B illustrates a plan view of the support device of the embodiment with a view looking on the fastening section 5. In the side surface 2a of the fastening section 5, there are two circular openings 7. The two openings 7 are mutually arranged parallel to the edges a of the body 1, approximately centrally with respect to the edges 1b. A condenser lens 7a (not shown) is arranged in each of the two openings. The two openings 7 constitute eye openings. If the support device has been fastened onto the user's face, the user will look through the openings 7 into the empty space that is inside the body 1.

In the side surface 2a of the fastening section 5, there is another opening 8a. The opening 8a extends from the middle of the side surface 2a, originating substantially in the shape of an isosceles triangle going in the direction of the edge 1a(2), and includes same. The opening 8a has an axis of symmetry. The axis of symmetry corresponds to the perpendicular bisectors on the connecting line between the center points of the two circular openings 7. The opening 8a is a part of the nose clip 8 of the support device. The nose clip also includes two nasal wings 8b. The two nasal wings 8b extend from the border area of the side surface 2a and opening 8a, from about halfway into the inner space of the body 1. The transition edges 9 between the side surface 2a and the two nasal wings 8b are folded then so that the two nasal wings 8b converge together inside the body 1.

An ear hook 10 is fastened onto the two side surfaces 4a, b of the body 1. The two ear hooks 10 are then arranged near the edges 1c(3) and 1c(4), respectively. The ear hooks 10 are substantially perpendicular to the side surfaces 2a, 2b of the body 1, and extend in the direction of the fastening section 5 away from the body 1. At the end not attached to the body 1, the two ear hooks 10 each have a roughly semicircular curvature. Such a curved progression is known from ear hooks of optical eyeglasses.

The fastening device of the support device is substantially formed of the nose clip 8, together with the two ear hooks 10. The fasten the support device onto the user's head, the support device is arranged on the user's head such that the nose clip 8 of the fastening section 5 is fitted onto the user's nose. The two ear hooks 10 are fastened onto the user's ears. Combining the nose clip 8 and the ear hooks 10 makes it possible to fasten the support device onto the user's head in a manner similar to optical eyeglasses. The side 2a of the fastening section then lies substantially on the user's face. If the support device has been fastened onto the user's face, then the eye openings 7 allow the user to look through the condenser lenses 7a into the empty space inside the body 1. If a display unit is fastened in the holding device of the support device, then the user of the support device looks frontally at the screen of the support device through the empty space in the inside of the body 1, the screen being arranged parallel to the side surface 2a in the holding section 6.

FIGS. 1C and 1D illustrate a plan view of the support device of FIG. 1B, with a view looking to the holding section 6. FIG. 1C illustrates the support device in a state in which there is no electronic display unit fastened in the holding device 11, whereas FIG. 1D illustrates the support device along with an electronic display unit fastened in the holding device 11.

The holding device 11 is arranged substantially on the side surface 2b of the holding section 6. The holding device is pocket-shaped. The holding device comprises an inner pocket boundary 11a and an outer pocket boundary 11b. The inner pocket boundary 11a extends substantially over the entire side surface 2b. The inner pocket boundary lla is connected integrally to the body 1 of the support device at all four edges of the side surface 2b. The outer pocket boundary 11b extends also over a large part of the side surface 2b. Only in the border area around the opposite edges 1b(3) and 1b(4), the outer pocket boundary 11b has omissions with respect to the side surface 2b. The outer pocket boundary 11b is connected integrally to the body 1 of the support device along the edges 1a(1) and 1a(4). Along the edges 1b(3) and 1b(4), the outer pocket boundary 11b is not connected integrally to the body 1. Thus, the pocket-shaped holding device 11 has two opposite opening regions along the edges 1b(3) and 1b(4). Via the opening regions, it is possible to insert an electronic display unit between the inner pocket boundary lla and the outer pocket boundary 11b laterally into the holding device 11, as illustrated in FIG. 1D. In the final holding position thereof, the display unit is arranged centrally on the side surface 2b of the holding device 11 and clamped between the inner pocket boundary 11a and the outer pocket boundary 11b. The screen of the display unit, which is to be viewed by the user with the aid of the support device, is then aligned parallel to the side surface 2b in the direction of the fastening section 5. In the region in which the screen intended to be viewed is located when in the holding position, the inner pocket boundary lla has a region that is transparent to light (not shown). This region may also be formed by an omission in the inner pocket boundary 11a. The outer pocket boundary 11b incompletely encloses a display unit located in the holding position. As can be seen in FIG. 1D, the two front regions of the display device are not covered by the outer pocket boundary 11b. This ensures that video cameras (not shown) of the display unit that are arranged in the region of the front sides can be used even when the display unit has been fastened into the holding device 11.

An insertion flap 11c is arranged in the region of each of the two openings of the holding device 11. The insertion flaps 11c are fastened onto the body 1 of the support device along the edges 1b(3) and 1b(4), respectively. The insertion flaps 11c, as can be seen in FIG. 1C, lie obliquely away from the body of the support device, if no display unit is present in the holding device 11. Should a display unit be present in the holding device 11 (FIG. 2B), then the flaps push from below against the display unit (not shown) present in the holding device 11. This also prevents the display unit from falling out of place in the holding device 11.

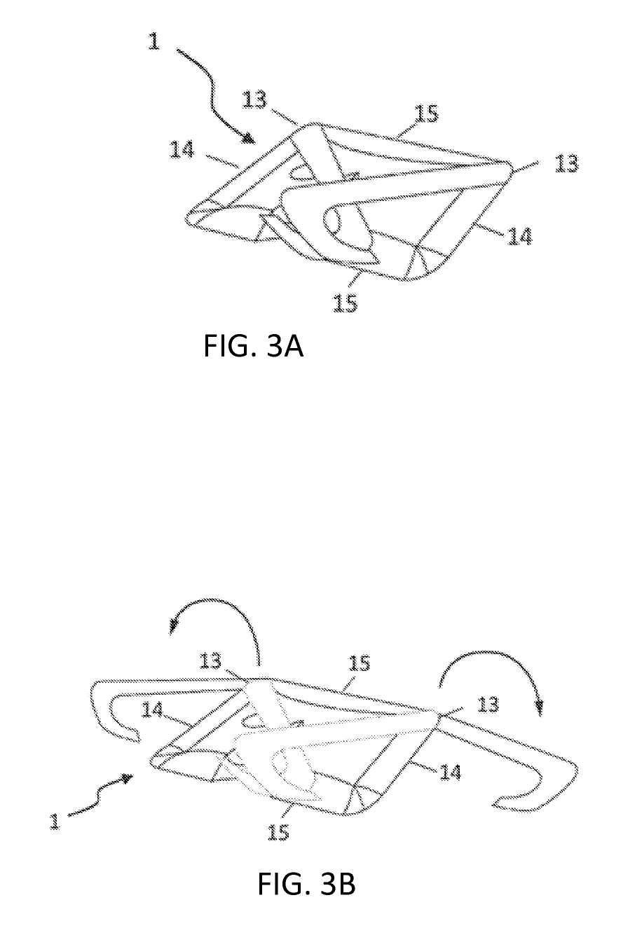

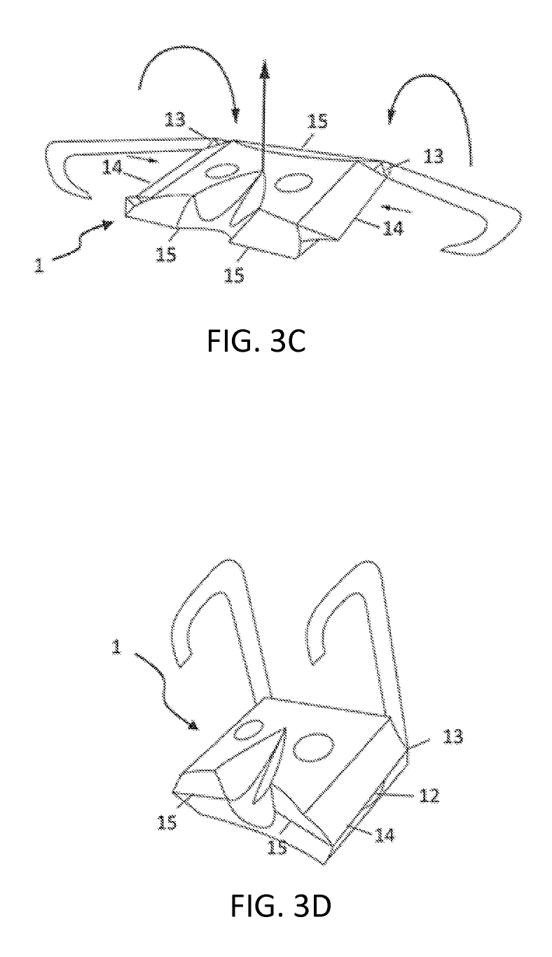

The support device further comprises an unfolding aid 12. The unfolding aid is designed as an engagement and arranged on the side surface 4a of the body 1 of the support device. The unfolding aid 12 serves to facilitate the transfer of the support device from the transport state into the display state, and vice versa. The reversible transfer of the support device between the operating states thereof by means of folding shall be described in greater detail later in the description, with reference to FIGS. 3A-3D.

FIG. 2 illustrates the support device in the transport state, i.e., in the state in which the support device occupies the smallest possible volume of space and cannot be fastened onto a user's face. In the transport state, the body 1 of the support device has substantially a flat, two-dimensional structure. The side surfaces 3a, b and 4a, b of the body 1 are then no longer substantially perpendicular to the side surfaces 2a, 2b, as is the case in the display state. Instead, the side surfaces 3a, b and 4a, b in the transport state are arranged substantially parallel to the side surfaces 2a, b, so that the entirety of the side surfaces of the body 1 form one substantially flat, two-dimensional structure. The body 1 occupies substantially no volume of space when in the transport state.

Also, the ear hooks 10 of the support device in the transport state are not substantially perpendicular to the surfaces 2a, 2b of the body 1 of the support device, as is the case in the display state. Instead, the ear hooks 10 in the transport state are arranged substantially parallel to the side surfaces 2a, 2b. The two ear hooks 10 are then folded crosswise one over the other and over the side surface 2a so that the ear hooks 10 in the transport state occupy substantially no additional volume of space as compared to the volume of space that is occupied by the flat, sheet-shaped body 1. In particular, the ear hooks 10 in the transport state do not jut out above the surface area of the body 1, which is sheet-shaped in the transport state, the surface area being defined by the side surfaces 2a, b.

The support device is transferred from the transport state to the display state, and vice versa, by means of folding along predefined fold seams. The transition from the transport state to the display state by means of folding shall be described below, with reference to FIGS. 3A to 3D.

FIG. 3A illustrates the support device in the same transport state as in FIG. 2. In the course of the transfer of the support device from the transport state to the display state, first the ear hooks 10 are unfolded. As can be seen in FIG. 3A, the ear hooks 10 in the transport state are arranged crosswise one over the other and substantially parallel over the side surface 2a of the flat body 1. The ear hooks 10 are now folded outwardly by 180°, as illustrated in FIG. 3B. The ear hooks 10 are unfolded here along the fold seam 13 that is predefined at the interface of the body 1 and the ear hooks 10.

After the ear hooks 10 have been folded outward, the flat body 1 of the transport state is converted into the substantially rectangular cuboid body 1 of the display state. This conversion is depicted in FIG. 3C. The conversion takes place substantially through the application of slight pressure to the fold seams 14, which are predefined in parallel to the edges 1b of the rectangular cuboid in the side surfaces 4a, b. Preferably, the slight pressure is applied to the fold seams 14 via the unfolding aid 12, which is arranged on the side surface 4a.

The lateral pressure to the fold seams 14 causes the flat body 1 of the transport state to be erected slowly along the fold seams 15 and 14 located in the side surfaces 3a, b and 4a, b, the fold seams running substantially parallel to the edges 1b of the rectangular cuboid, and causes the body 1 to turn into the substantially rectangular cuboid body 1 of the display state. In the course of this transition, the nasal wings 8b, which are arranged substantially parallel to the side surfaces 2a, b in the transport state, are also aligned in the direction of the inner space of the resulting three-dimensional, rectangular cuboid body 1 of the display state.

The erection of the formerly flat body 1 causes the two ear hooks to also automatically be erected from the outwardly bent position thereof (see FIG. 3B) and assume the orientation thereof corresponding to the display position, as illustrated in FIG. 3D. In the display state, the ear hooks 10 stand in the longitudinal axis thereof substantially perpendicular to the side surfaces 2a, b of the substantially rectangular cuboid body 1 of the support device.

FIG. 3D illustrates the support device after completion of the transfer from the transport state to the display state, i.e., in the identical display state of FIG. 1B.

The process of transferring the support device from the transport state to the display state, as described with the aid of FIGS. 3A to 3D, is reversible. The support device can be transferred from the display state to the transport state as many times as desired by reversing the steps described in FIGS. 3A to 3D.

We claim:

1. A support device for an electronic display unit, the support device comprising:
a holding device for holding an electronic display unit on the support device; and
a fastening device for fastening the support device onto a user's head,
wherein the support device is foldable and designed so as to be able to assume at least two operating states,
one being a first operating state in which the support device has a flat, substantially spatially two-dimensional volume and cannot be fastened onto the user's head, and
the other being a second operating state in which the support device has a spatially three-dimensional volume and can be fastened onto the user's head, and
wherein folding along predefined fold seams makes it possible to transfer the support device from the first operating state to the second operating state, and vice versa.

2. The support device according to claim 1, wherein the support device comprises a substantially rectangular cuboid base body, the base body comprising:
a front side on which the holding device is arranged;
a reverse side in which two circular eye openings are arranged; and
side surfaces, wherein arranged along the side surfaces are at least partially predefined fold seams that run substantially parallel to the front side and the reverse side, and wherein folding along the predefined fold seams makes it possible to transfer the base body from the second operating state to the first operating state, and vice versa.

3. The support device according to claim 2, wherein an ear hook is arranged on each of the side surfaces of the base body and, in the second operating state, the ear hooks stand substantially perpendicular to the front side and the reverse side and extend in the direction of the reverse side away from the base body.

4. The support device according to claim 1, wherein the support device can be fastened onto the user's head in the second operating state by means of the fastening device so that a screen of the electronic display unit present in the holding device is arranged substantially frontally and at a fixed distance in front of the user's eyes.

5. The support device according to claim 1, wherein in the second operating state, an enclosed space between the screen and the user's eyes is bounded by the sides of the support device, so that substantially no light is able to penetrate into the enclosed space from outside the support device.

6. The support device according to claim 1, wherein the support device comprises at least one optical condenser lens, which is arranged in front of the user's eyes in the second operating state, in the enclosed space between the screen and the user's eyes.

7. The support device according to claim 1, wherein the fastening device comprises two ear hooks and one nose clip, by means of which the support device can be fastened onto the user in the second state.

8. The support device according to claim 7, wherein the longitudinal axes of the two ear hooks are arranged substantially parallel to the spatially two-dimensional volume of the support device in the first operating state, and are arranged in the second operating state so as to state substantially perpendicular to the screen of the electronic display unit provided in the holding device.

9. The support device according to claim 1, wherein the support device in the first operating state substantially encloses the electronic display unit present in the holding device.

10. The support device according to claim 1, wherein the support device is made substantially form a flexible and foldable material, in particular from paper, metal, cardboard, leather, or plastic.

11. The support device according to claim 1, wherein the electronic display unit is a mobile telephone, a smartphone, a mobile video player, a mobile image playback unit, or any other mobile display unit having a screen.
